(19) United States
(12) Patent Application Publication
(10) Pub. No.: US 2006/0225507 A1
(43) Pub. Date: Oct. 12, 2006

(54) Pipeline monitoring system

(76) Inventor: Peter O. Paulson, Calgary (CA)

Correspondence Address: BLAKE, CASSELS & GRAYDON, LLP, 45 O'CONNOR ST., 20TH FLOOR, OTTAWA, ON, K1P 1A4, CA

(21) Appl. No.: 10/541,890

(22) PCT Filed: Jan. 13, 2004
(86) PCT No.: PCT/CA04/00008

§ 371 Date: Apr. 13, 2006

(30) Foreign Application Priority Data
Jan. 13, 2003 (CA) 2,416,171

(51) Int. Cl. G01N 29/14; G01M 3/24; G01N 25/72

(52) U.S. Cl. 73/592; 73/40.5 A; 374/4

(57) ABSTRACT

Process and apparatus for sensing possible leaks in a pipeline. The pipeline is monitored continuously by acoustic monitoring means, and acoustic events indicating a possible leak are noted. The pipeline is also equipped with temperature monitoring means, and is monitored for temperature either continuously, periodically or on demand. A leak is deemed probable at any location where there is an acoustic event indicating a possible leak, and at approximately the same time, a temperature difference greater than a pre-chosen amount between that location and adjacent locations

### FIELD OF THE INVENTION

The present invention relates to pipeline monitoring systems and in particular to systems for detection of leaks in a pipeline.

### BACKGROUND OF THE INVENTION

The invention provides a monitoring system for pipelines and provides for detection of pipeline leaks, such as those caused by impact to the pipeline or by ageing of the pipeline, which cause escape of fluid from the pipeline to the surrounding environment.

Generally, pipelines that carry fluids are buried underground and are therefore protected to some extend from damage from impact and the like. However, surface deployed pipelines are also used to transport fluids such as oil. Such pipelines have been installed particularly in Arctic areas, where buried pipelines are not preferred because permafrost can be unstable as a bed for a buried pipeline. Surface deployed pipelines are subject to environmental exposure including wind, rain, and sunlight, and are also subject to being damaged by falling rocks or earthslides, or by collisions with man-made objects such as snowmobiles or trucks or the like. When a leak occurs in an environmentally sensitive area such as in an Arctic wilderness area, the escape of the oil or other fluid being transported through the pipeline can cause environmental contamination, as well as the economic loss that occurs from the loss of the oil itself.

Pipelines, especially above-ground ones, are also subject to vandalism and terrorism, and to deliberate making of holes in them to steal the contents. Deliberately made holes in pipelines without the consent of the pipeline's owner, whether for the purpose of vandalism, terrorism or stealing of pipeline contents, are included in the term “leak” as used in this disclosure.

In the past, it has been proposed to monitor pipelines for leaks using acoustic apparatus. See for example Canadian patent no. 2,066,578, which uses a plurality of acoustic sensors. It is possible to use acoustic sensors to hear noises (known as “acoustic events”) and it is possible to determine the location at which a specific acoustic event has occurred. However, it is much more difficult to determine the meaning of the acoustic events, and whether they relate to a leak. When a pipeline runs above ground, acoustic sensors are particularly likely to give false positive readings due to the surrounding environmental conditions. For example, wind, rain, lightning, and other naturally occurring effects can produce acoustic events that may appear to indicate that a leak or collision with the pipeline has occurred, when in fact such a collision or leak has not occurred.

### SUMMARY OF THE INVENTION

The present invention provides a system for monitoring of a pipeline for leaks by doing acoustic monitoring of the pipeline and also by detecting changes in temperature on or near the exterior of the pipeline. The temperature information asks as a validity check on acoustic monitoring results which may indicate that a leak has occurred. The invention is particularly well suited to the monitoring of above ground pipelines, although it can be used with underground pipelines as well.

The term “distributed sensor” is used herein to mean a single elongated sensing unit which can sense and report values of the parameter being measured at various locations along its length. For example, a fibre optic distributed temperature sensor can be a fibre optic cable of several hundred metres to more than 10 kilometers in length, which can sense and output data on the temperature at any location along its length. A fibre optic distributed acoustic sensor can be a fibre optic cable of several hundred metres to more than several kilometers in length, which can sense and output data on acoustic events impinging it at any location along its length, or (if so designed) at discrete separate locations along its length.

According to the invention, a series of acoustic sensors or a distributed acoustic sensor monitor a length of pipeline. A temperature monitoring means is placed to monitor the same length of pipeline. The temperature monitoring means can be a distributed temperature sensor, or a series of conventional temperature sensors, placed exterior to the pipeline, on or adjacent to it. Alternately, if the pipeline is above ground and is substantially completely visible from one or more satellites or from the air, the temperature monitoring means can be one or more satellite-borne sensors or one or more sensors borne on an aircraft or drone aircraft.

The acoustic monitoring is continuous. In a preferred embodiment, the temperature monitoring is also continuous. However, if desired, the temperature monitoring can be periodic (as when a temperature-monitoring satellite sweeps into monitoring range), or it can only be done when needed to verify an acoustic event of interest (as by sending a drone aircraft with a temperature sensor to examine a portion of the pipeline where an acoustic event of interest has occurred.)

In a particularly preferred embodiment, the temperature sensor is a distributed fibre optic thermal sensor capable of sensing temperature along a considerable length of pipeline, and it monitors temperature continuously, and the acoustic sensing is done by a distributed acoustic sensor. In such a case, the acoustic and temperature sensors can use the same optical fibre or can use different optical fibres.

The output of the acoustic monitoring is compared with normal background acoustic noise for anomalies and the presence of an acoustic anomaly is selected as an acoustic event of interest. Where there is continuous temperature monitoring, the output of the temperature sensor is monitored for anomalies, and the presence of an anomalous high or low temperature is selected as a temperature event of interest. When events of interest are found by the acoustic sensor and the temperature sensor at the same location and approximately at the same time, a leak is suspected. The recognition of the coincidence of these anomalies allows the rejection of false alarms from sources other than leaks, which could lead to anomalies in either acoustic events or temperature changes, but are not likely to lead to both at approximately the same time in the same location.

This embodiment makes use of the fact a leak is likely to cause a temperature anomaly in its vicinity exterior to the pipeline. In a case where the pipeline carries a liquid, the liquid is quite likely to be at a different temperature than the ambient temperature. Even in a case where the liquid is at substantially the same temperature as ambient, the ambient temperature will change over time, whereas the temperature of the liquid leaking from the pipe will not change temperature as quickly. If a liquified gas is being carried in the pipeline, the drop in pressure at the leak will cause the liquid to gasify, thus cooling the vicinity of the leak.

Many other things could heat or cool a portion of the pipeline, so that a temperature change is not necessarily an unequivocal indication of a leak. However, it provides a good verification that the acoustic event of interest was caused by a leak.

### DETAILED DESCRIPTION OF THE INVENTION

Acoustic events give rise to sound (acoustic waves) and pressure (seismic waves). Such events can be detected by a sensor for sound waves (such as a microphone) or a sensor for pressure waves (such as a piezzoelectric device). Sensors for sound waves and/or seismic waves will be called collectively “acoustic sensors”.

A leak in a pipeline is an acoustic event, as it results in fluid being expelled from the pipeline under pressure. A collision of an object or vehicle with the pipeline is also an acoustic event. Either can be detected by appropriate acoustic sensors. However, many other things give rise to acoustic events as well. When a pipeline is located above the surface of the ground, it is exposed to environmental factors including wind, rain, lightning and hail. These environmental factors can produce acoustic outputs that are similar to outputs produced when a leak of the fluid from the pipeline or a collision occurs. However, because there is a plurality of acoustic sensors (or a distributed fibre optic sensor) spaced over the length of the pipeline being monitored, and because an environmental factor such as rain or wind will occur along a substantial portion of the pipeline under test, the effect of an environmental factor will generally be monitored as occurring over a relative long length of pipeline. On the other hand, a leak will produce a variation in output which has its origin in a localized segment of the pipeline in the area of the leak. Such an acoustic event, unless its nature unequivocally identifies it as something other than a leak, is an acoustic event of interest for the invention.

Sound waves and seismic waves travel along a pipeline at a relatively constant rate characteristic of the materials of which the pipeline is made, and it is known to determine the origin of an acoustic event by sensing the relative times when it is detected at several acoustic sensors along the pipeline. Conventional acoustic sensors, such as microphones, piezzoelectric devices are located along the pipeline at spaced intervals. Generally, they are on or adjacent to the exterior surface of the pipeline, but some acoustic sensors, such as hydrophones, can be located within the pipeline. In general, having an acoustic sensor located every 100-200 metres along the pipeline is usually enough to acquire data as to the location at which an acoustic event happened, when the acoustic event is a large one, such as a collision with the pipeline or a rupture. If it is desired to capture acoustic data associated with smaller acoustic events, such as the event caused by small leak such as a corrosion leak, a sensor should be placed every 5-10 metres along the pipeline. Where there is a discontinuity in the pipeline, such as a sharp bend, it may be advisable to space the acoustic sensors more closely near the discontinuity, for example, so that there is one on each side of the discontinuity close to the discontinuity. Acoustic sensors external to the pipeline need not be in a position where they are contacted by the leaked fluid.

The acoustic and seismic waves from a collision or leak extend beyond the actual site of the collision or leak. Typically, they will be received at several sensors, with the sensors closest to the point of collision or leak receiving them first, then those farther away receiving them. The waves pass down the pipeline in both directions, so they are typically received by sensors both upstream and downstream from the leak (having regard to the direction of flow in the pipeline. As they progress to more distant sensors, they become fainter.

As is well known in the art, the point of origin of an acoustic event detected by conventional acoustic sensors can be determined by knowing the relative times that waves from the event hit several sensors.

The preferred type of acoustic sensor is a fibre optic interferometric distributed acoustic sensor deployed along the pipeline either in contact with it or close proximity to it. One suitable type of distributed acoustic sensor is available from Optiphase, Inc., 7652 Haskell Ave. Van Nuys, Calif. 91406, USA. The sensor can be placed along the exterior insulating jacket of the pipeline or affixed to the exterior of the pipe itself. A fibre optic sensor of this sort can be designed to detect acoustic events at all locations along the cable, or it can be shielded so that it detects acoustic events only at desired sensing points. Fibre optic acoustic sensors can be either a single cable or a looped cable sensing using interferometric effects. By analyzing the light coming out of the end of the cable, one can determine at which of the locations the event has been recorded and information about the nature of the event. With a cable that detects events at all locations along it, the origin of an event of interest can be determined directly from the signal. With a cable that detects only at desired sensing points, the origin of an event of interest can be calculated in the same way as is done is done with conventional sensors.

As a less preferred alternative, piezoelectric acoustic sensors or microphones can be mounted on or in the pipeline, as shown in Canadian Patent 2,066,578, or hydrophones can be mounted in arrays in the pipeline, as shown in U.S. Pat. No. 6,082,193.

Each of the sensors placed along the pipeline provides a monitoring for acoustic signals in the region of the pipeline over which the sensor is sensitive. When acoustic events are detected, their origin is determined, either by calculating from the relative times at which the same event is recorded at several locations, and knowing the speed of travel of sound along the pipeline, or by direct readoff in the case of some distributed acoustic sensors.

Events which have an origin over a long length of the pipeline are considered to be likely to be caused by environmental factors, and are not considered further. If desired, criteria (as for example the amplitude, duration, acoustic frequencies) can be pre-chosen according to the nature of the pipeline, and signals exhibiting these criteria can then be excluded from consideration, because previous investigation of similar events have shown that they do not represent leaks or collisions. Events having particular origins can be excluded because there is a known cause for such events (eg. work being done on a particular part of the pipeline.). Events having their origin in one short length of the pipeline, and not excluded by pre-established criteria (if such criteria exist) are considered as acoustic events of interest for the purpose of the invention.

It is possible that an acoustic event of interest (as discussed above) could occur and not indicate pipeline damage, as when there is localized noise from wind and blowing snow. For this reason, results from temperature sensing are also considered.

The preferred temperature sensor is a fibre optic distributed temperature sensor deployed continuously along or in close proximity to a pipeline A suitable sensor can be obtained from Sensa, Gamma House, Enterprise Road, Chilworth Science Park, Southampton SO16 7NS, England. The sensor is equipped with a laser light source, which sends a light beam through the fibre optic cable, and with a reflector at the far end, which reflects the light back to its source, where it is analyzed. Alternate forms of the sensor use a loop, where the light passes down one side of the loop, around the end, and back in the other side of the loop to its origin. The two sides of the loop can be laid, for example, on opposite sides of the pipeline being monitored. Changes in temperature in the fibre optic cable outputs a change in the character of the light at the end of the fibre. Variations in the light received allow substantially continuous assessment of the temperature of the fibre along its length. Such a sensor will register a temperature fluctuation as small as plus or minus 1 Degrees C., with a location accuracy of plus or minus 10 metres, in a cable of 10 Kilometers in length.

Preferably the temperature fluctuations long the length of the cable are monitored continuously. The fibre optic cable can be placed on the underside of the pipeline, or on or in the ground just below it, so that liquid dripping from a leak will contact it, or it can be wound spirally around the pipeline, or be otherwise disposed so that pooling liquid from a leak will contact it. More than one sensor cable can be present if desired, for example one lying along each side of the pipeline, near the underside.

In an alternative embodiment, the temperature sensors can be conventional thermometers or thermocouples which sense a temperature rise (if the fluid in the pipeline is hotter than its environment) or a temperature fall (if the fluid in the pipeline is colder than its environment). Generally, the thermometers or thermocouples need not be very sensitive. Thermometers or thermocouples which register a change of about 2° C. are suitable for most installations. In some installations, where there is a large difference between the temperature of the fluid in the pipeline and the environmental temperature, thermocouples or thermometers which are even less sensitive (for example, which respond to a 5° C. change), may be suitable. The accuracy of the thermocouple or thermometer is seldom important, as all that needs to be measured in most cases is the fact that a change of temperature of at least a certain magnitude has occurred; the absolute value of the temperature does not need to be known. The temperature sensors (thermocouples or thermometers) are spaced a desired distance from one and are all coupled to one or more central monitoring stations, where changes in temperature and preferably the time of their occurrence, are recorded or noted.

The desired spacing of the sensors depends upon the nature of the fluid and the nature of the terrain, and is chosen to detect escaped fluid before a very large pool has collected. Usually, placement of sensors every 0.5 m to every 5 m. is sufficient and spacing may vary according to the terrain the pipeline passes through if desired. The temperature sensors are normally placed on the underside of the pipeline, or on or in the ground just below it, so that liquid dripping from the pipeline will contact them.

If the pipeline is above ground, one or more infrared sensors mounted on a satellite or drone aircraft and calibrated to read temperature can be used instead of thermocouples, thermometers or a distributed sensor. The infrared sensors scan the length of the pipeline, looking for temperature changes on its exterior, either or a continuous, periodic or “on demand” basis.

With any type of temperature sensor, if there is a temperature change sensed of more than an arbitrary amount along an arbitrarily small length of the pipeline, but not on adjacent lengths of the pipeline, this is considered as a “temperature event of interest” for the purpose of this invention. However, a change of temperature along the whole pipeline (as for example on an above ground pipeline because the day gets warmer) is not considered as a event temperature event of interest.

As an example, for a particular pipeline carrying hot oil, the arbitrarily small length of pipeline can be defined as 10 metres, and the arbitrary change in temperature can be defined as a temperature at least 2° C. higher than the temperature of the pipeline immediately adjacent the arbitrarily small length. Whenever the sensor system notes a length of pipeline of 10 metres or less which is associated with an average sensed temperature at least 2° C. higher than the average temperature associated with the lengths of pipeline immediately adjacent to it on either side, the system would consider this as a temperature event of interest. The term “associated with” is used because it is not necessary to measure the temperature of the exterior of the pipeline itself. It is also possible to measure adjacent the pipeline, in a location where fluid which escapes from the pipeline is likely to collect.

If the temperature sensors are sensitive enough, they can give useful information to verify the acoustic indications of a possible leak, even when the temperature of the fluid in the pipeline is approximately ambient. For example, in a pipeline which is above ground, external ambient temperatures are likely to fluctuate, while the temperature of escaping liquid will change more slowly, causing an anomaly. In a below ground pipeline, the heat-conducting properties of the fluid will be different from that of the ground, also causing an anomaly.

Often, prior to declaring that a temperature event of interest occurs, other verification can be done. For example, it may be possible to determine from previous system records that the pipeline segment in question is typically warmer than other segments on sunny days, and a check can be made to see if the sun is shining at the time the temperature event of interest occurs. Also, the sensed temperature can be compared with the expected fluid temperature at that location, to see if the temperature sensed is likely to be that of the fluid.

When both an acoustic event of interest and a temperature event of interest occur, at locations close to each other and within a short time period of each other, a leak is suspected, and corrective action is taken. The precise criteria of closeness of location and closeness of time period will be set considering the particular pipeline, and the nature and spacing of its sensors. As an example, acoustic and temperature events of interest happening within about 10-20 metres of one another within a 10-20 minute period are strongly indicative or a leak. The corrective action taken may depend on the magnitude of the acoustic and temperature anomalies.

### BRIEF DESCRIPTION OF THE DRAWINGS

The preferred embodiments of the invention will now be described in detail with reference to the following drawings in which:

FIG. 1 is an elevation view (not to scale) of a portion of a pipeline configured with monitoring apparatus in accordance with the invention.

FIG. 2 is a cross-sectional view (not to scale) of a portion of a pipeline configured with two other embodiments of monitoring apparatus in accordance with the invention.

### DETAILED DESCRIPTION OF THE PREFERRED EMBODIMENTS

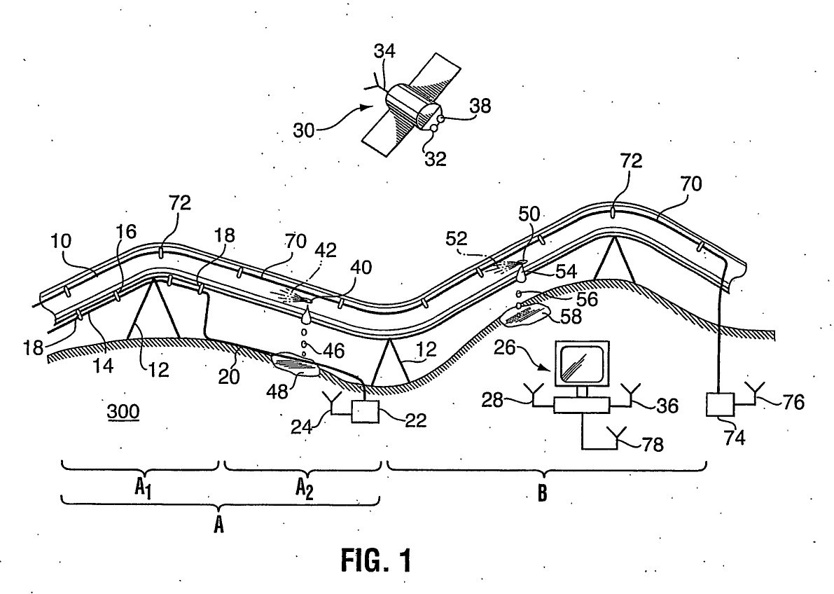

FIG. 1 shows an elevation view of a portion of a pipeline 10 which is disposed above the surface of the ground and supported on a plurality of pedestals 12 as it traverses the terrain 300 over which the pipeline is deployed. The pipeline 10 takes a zigzag configuration as is customary in above ground pipeline construction to enable the pipeline to maintain integrity despite the expansion and contraction that will occur through seasonal heating and cooling of the pipeline along its length over the course of the year. When pipeline 10 is buried below ground, the more customary configuration of the pipeline structure is a substantially linear configuration along the distance over which it extends.

In the example, the fluid which passes through the pipeline is oil, at a temperature higher than the ambient temperature (for example 10 degrees C. higher). Two embodiments of the invention, which differ in how the temperature monitoring is done, are shown in FIG. 1. The first embodiment monitors the length of pipeline indicated as “A”. The second embodiment monitors the length of pipeline indicated at “B”.

Dealing first with the embodiment monitoring length “A”, a distributed fibre optic temperature sensor 14 (for example, one available obtained from Sensa, Gamma House, Enterprise Road, Chilworth Science Park, Southampton SO16 7NS, England) is shown extending along the length A of pipeline 10. In the embodiment of FIG. 1, temperature sensor 14 is affixed to the underside of the pipeline, as at 16, by suitable attaching clips 18, for a portion A₁ of the length that it monitors. For illustration, for the remainder A₂ of the length which the sensor monitors, it is disposed on the ground under the pipeline, as at 20.

The distributed fibre optic sensor terminates at a box 22, which contains its laser light generator and data collection and storage media. The box is connected by a link 24, which can be for example wired, wireless, optical or infrared, to a suitable monitoring station 26. In the drawing, link 24 is shown as an antenna on box 22, which transmits to an antenna 28 on monitoring station 26, which is represented here as a computer. Suitably the monitoring station 26 can be at a location remote from the pipeline being monitored.

Another section of the pipeline 10, represented as B, has its temperature monitored by a satellite, aircraft, or pilotless drone aircraft 30. This has an infrared sensor 32 with which to scan the section B of pipeline 10 and an antenna 34 to transmit the data from the scan to antenna 36 on monitoring station 26. The link represented by antennae 34 and 36 is any suitable wireless data transmission means, such as a microwave, other wireless, optical or infrared data link. Monitoring by the satellite, aircraft or drone may be continuous or periodic. Continuous monitoring is of course usually preferable, as it may permit earlier detection of leaks, but periodic monitoring may be preferable for cost reasons.

Both sections “A” and “B” have their acoustic monitoring done by an interferometric acoustic sensor 70 (eg. from Optiphase, Inc., 7652 Haskell Ave. Van Nuys, Calif. 91406, USA) which is 1 Km. in length or some other convenient length, and which is designed to do continuous acoustic sensing over its length. Sensor 70 is attached to the exterior insulation surface of the pipeline by suitable clips 72. Sensor 70 terminates in a box 74 which has the laser needed to shine light through it and data recording media. It is also equipped with an antenna 76 (or wired, optical or infrared connections) for transmitting data to monitoring station 26. In the illustration, monitoring station 26 is equipped with antenna 78 to receive the data.

The particular sensor 70 is one that can sense acoustic events at all locations along its length. However, it would be possible to use a sensor which sensed acoustic events only at discrete points along its length if desired.

As shown in FIG. 1, a leak has occurred in the pipeline at 40. This may have occurred for example through corrosion, collision with some object, or vandalism. Liquid sprays out of the pipe in jet 42, which may fall to the ground some distance from the pipeline. However, some liquid also dribbles down the side wall of the pipeline as at 44, and drips to the ground as at 46, to form a puddle 48 directly below the pipeline.

The formation of the leak at 40 caused an acoustic event, and the spraying out of the oil as at 42 is an ongoing acoustic event. The distributed acoustic detector therefore logs acoustic events occurring at the location 40 on the pipeline, which acoustic events do not extend over a long portion of the pipeline. They are therefore logged as acoustic events of interest.

If the leak had occurred where the sensor 14 was attached to the bottom of the pipe in section A₁, as at 16, the dribble 44 would have contacted the sensor as it went along the surface of the pipe. As shown, the leak occurs in Section A₂, so the puddle 48 contacts the sensor. In either case, the dribble or puddle has a temperature sufficiently higher than the temperature of the surrounding environment so that the sensor 14 records the higher temperature and it is recognized by the monitoring station as a temperature event of interest. The location is approximately below location 40 on the pipeline.

As there is an acoustic event of interest and a temperature event of interest at location 40, human inspection of that specific location on the pipeline can then be arranged, if no explanation of the anomalous events is available.

A leak has also occurred at location 50, within the portion of the pipeline B which is monitored by satellite or drone 30. Analogous to leak 40, there is a jet 52 of liquid, a dribble 54 down the pipeline drops 56 and a puddle of liquid 58.

As with leak 40, acoustic sensor 70 logs as acoustic events of interest both the initial rupture causing the leak and the ongoing sound of escaping liquid, as at 52.

In this case, the temperature sensor 32 may sense an elevated temperature from any of jet 52, dribble 54, drops 56 or puddle 58. In any event, a temperature event of interest is noted at a location along the pipeline at a location corresponding to the acoustic event of interest. A human could be sent to investigate. However, this particular system has a camera 38 mounted on drone, aircraft or satellite 30, and it may be desired to take pictures of the area of the suspected leak, to see the situation before deciding whether to send a human.

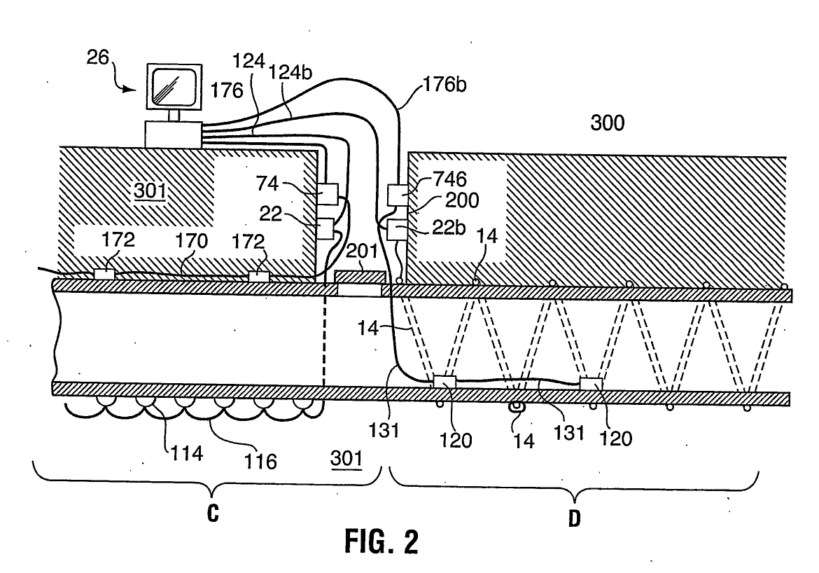

FIG. 2 shows an installation of the invention in an underground pipeline. The reference numerals are the same as in FIG. 1, where like elements are shown. In this case, pipeline 10 is shown in cross-section. It does not have a zig-zag configuration, as such configuration is typically only used with above-ground pipelines. Pipeline 10, as shown, has two sections C and D, which are monitored with different equipment according to two further embodiments of the invention. Numeral 300 indicates the ground surface, while 301 indicates the subterranean earth and rock, seen in cross-section.

Pipeline 10 is accessed through access well 200, which permits access to hatch 201 which gives access to its interior.

In the example, the pipeline 10 carries liquid ammonia. If the ammonia escapes through a leak, the escaping ammonia will expand and its pressure will drop, causing it to cool, and to cool the surrounding exterior surface of the pipeline and the surrounding earth.

The monitoring system used in sector C of the pipeline is now described. Along the bottom of pipeline 10 is a series of temperature sensors 114, linked by cable 116, which passes upward through well 200 to a data collection device 22, shown mounted on the wall of well 200. The data collection device collects data from the individual sensors and transmits it to a remote monitoring station 26. In the present example, the transmission is done by land line 124, although it could instead be done by wireless means as shown by elements 24 and 28 in FIG. 1. Attached to the exterior of the pipeline are also acoustic sensors 172, which for example can be microphones or piezzoelectric devices conventionally used for acoustic monitoring of structures. They are connected by a cable 170 (which is not itself a sensor). The cable passes up the service well 200 to a data collection device 74, which is suitably connected as by cable 176 (or a wireless connection, as in FIG. 1) to a monitoring station 26.

The monitoring system used in sector D is now described. A distributed temperature sensing cable 14, as used in the embodiment of FIG. 2, is used. However, in this example, it is helically would about the pipeline 10. Clips 18 are not needed to keep it is place, as it is kept in place by the rock and earth surrounding the pipeline. Cable 14 is connected to data collection box 22b, which is connected to monitoring station 26 by suitable data transmission means (here shown as land line 124b, although wireless means can be used). Within the pipeline, there is an array of acoustic sensors (which in this example are hydrophones 120), linked by a cable 131. These can rest on the bottom of the interior of the pipeline as shown, or be suspended in the flow of the fluid within it. Cable 131 extends out of the pipeline and up the service well 200 to a data collection device 746, which in this example is connected to the remote monitoring station by cable 176b.

Although the sensors shown in FIG. 2 are different from those in FIG. 1, the method of operation is exactly like that of FIG. 2. If there is a leak (no leak is shown in the Figure), escaping ammonia vapour from the pipeline would make a sound, which would be logged as an event of acoustic interest by either sensors 172 or 120, and the origin of the sound would be determined by calculation as known in the art. The escaping vapour (which is cooler than the surrounding earth because it loses heat through vaporization and expansion) would contact a temperature sensor, either an individual sensor 114 or the distributed sensor 14, causing a temperature event of interest, and the location of that event would be logged. If an acoustic event of interest and a temperature event of interest occur within a pre-chosen period of time at approximately the same location, a leak at that location is suspected and appropriate action is taken.

It is understood that the invention has been described with respect to specific embodiments, and that other embodiments will be evident to one skilled in the art. The full scope of the invention is therefore not to be limited by the particular embodiments, but the appended claims are to be construed to give the invention the full protection to which it is entitled.

What is claimed is:

1. A process for locating a leak in a pipeline, which comprises:
(a) continuously sensing acoustic events which occur in proximity to the pipeline and the location along the pipeline at which they occur, selecting those consistent with a leak in the pipeline or a collision with the pipeline as acoustic events of interest; and noting the location or locations where they occur;
(b) sensing the temperature along the pipeline;
(c) noting any locations along the pipeline where the temperature differs from the locations adjacent to it by a predetermined amount; noting any such location as a location of a temperature event of interest,
(d) when an acoustic event of interest and a temperature event of interest occur within a preselected time period at approximately the same location along the pipeline, noting such location as the probable site of a leak.

2. A process as claimed in claim 1, in which the sensing of the temperature along the pipeline is done continuously.

3. A process as claimed in claim 1 in which the sensing of the temperature along the pipeline is carried out with sensing apparatus oriented so that fluid escaping from the pipeline is likely to contact it.

4. A process as claimed in claim 1 in which the sensing of acoustic events is carried out by a distributed fibre optic acoustic sensor.

5. A process as claimed in claim 1 in which the sensing of temperature is carried out by a distributed fibre optic temperature sensor.

6. A process as claimed in claim 1 in which the pipeline is at least partially above ground.

7. Apparatus for sensing leaks in a pipeline, which comprises:
(i) temperature sensing means for determining temperature along the exterior of the pipeline;
(ii) means for collecting data sensed by such temperature sensing means and for determining locations, if any, where the temperature of the exterior of the pipeline differs by at least a predetermined amount from the temperature of the exterior of the pipeline at adjacent locations along it;
(iii) acoustic sensing means for detecting acoustic events occurring along the pipeline, and the location of such events; and
(iv) means for collating the output of such acoustic sensing means and said temperature sensing means to determine situations where there is an acoustic event, with a substantially contemporaneous temperature change occurring at the same location.

8. Apparatus as claimed in claim 7, in which the pipeline is substantially above ground and visible from above, and the temperature sensing means is mounted on an air or space-borne vehicle.

9. Apparatus as claimed in claim 7, in which said temperature sensing means is a distributed fibre optic temperature sensor.

10. Apparatus as claimed in claim 9, in which the distributed fibre optic temperature sensor is below the pipeline and substantially adjacent to it, whereby liquid leaking from the pipeline is likely to impinge on such sensor.

11. Apparatus as claimed in claim 7, in which the acoustic sensing means is a distributed fibre optic acoustic sensor.

12. Apparatus as claimed in claim 8, in which the acoustic sensing means is a distributed fibre optic acoustic sensor.

13. Apparatus as claimed in claim 9, in which the acoustic sensing means is a distributed fibre optic acoustic sensor.

14. Apparatus as claimed in claim 10, in which the acoustic sensing means is a distributed fibre optic acoustic sensor.

15. Apparatus for sensing leaks in a pipeline which comprises:
(a) a fibre optic distributed acoustic sensor;
(b) means for analyzing the data output of such fibre optic acoustic sensor resulting from acoustic events impinging on it;
(c) means for selecting from such analysis of acoustic events and their location of origin along the pipeline.

16. Apparatus as claimed in claim 15, including means for selecting as anomalous events those events which appear to have their origin in a single short length of the pipeline.

17. A process as claimed in claim 2, in which the sensing of acoustic events is carried out by a distributed fibre optic acoustic sensor.

18. A process as claimed in claim 3, in which the sensing of acoustic events is carried out by a distributed fibre optic acoustic sensor.
